(19) United States
(12) Patent Application Publication
(10) Pub. No.: US 2015/0103181 A1
(43) Pub. Date: Apr. 16, 2015

(54) AUTO-FLAT FIELD FOR IMAGE ACQUISITION

(71) Applicant: Checkpoint Technologies LLC, San Jose, CA (US)

(72) Inventor: Jianxun Mou, Fremont, CA (US)

(73) Assignee: Checkpoint Technologies LLC, San Jose, CA (US)

(21) Appl. No.: 14/055,816

(22) Filed: Oct. 16, 2013

(51) Int. Cl. H04N 5/357; H04N 5/33; G06T 5/00

(52) U.S. Cl. CPC H04N 5/357; G06T 5/00; H04N 5/33
USPC 348/162; 348/241

(57) ABSTRACT

Image correction may comprise acquiring a pixel value for each pixel in a raw image of a sample; obtaining a corresponding filtered pixel value for each pixel in the raw image by applying a filtering function to a subset of pixels in a window surrounding each pixel; obtaining pixel values for a final image by performing a pixel-by-pixel division of each pixel value of the raw image by the corresponding filtered pixel value; and displaying or storing the final image. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE DISCLOSURE

Embodiments of the present disclosure relate to digital image signal processing, and more particularly to image of non-uniform image noise.

### BACKGROUND

Imaging systems utilize one or more detecting elements to produce an array of values for corresponding picture elements often referred to as “pixels.” The pixels are usually arranged in a two dimensional array. Each pixel value may correspond to intensity of some signal of interest at a particular location. The signal may be an electromagnetic signal (e.g., light), an acoustic signal, or some other By way of example, in an optical imaging system, a region of interest is illuminated with radiation in some wavelength range of interest. Radiation scattered or otherwise generated by the region of interest may be focused by imaging optics onto one or more detectors. In some systems an image of the region of interest is focused on an array of detectors. Each detector has a known location and produces a signal that corresponds to a pixel of the image at that location. The signals from the detectors in the array may be converted to digital values and that may be stored in a corresponding data array and/or used to display the pixel data as an image on a display. In some systems, a narrow beam of illumination is scanned across a region of interest in a known pattern. An imaging system focuses radiation scattered from the illumination beam or otherwise generated at different known points in the pattern onto a single detector, which can be recorded as a function of time. If the illumination scanning pattern is sufficiently well known, the detector signal at plurality of instances in time can be correlated to the location of the illumination beam at those instances. The detector signal can be digitized at those instances of time and stored as an array of pixel values and/or used to display the pixel data as an image on a display.

Images collected from imaging systems often include inherent artifacts that results from non-uniform noise or background. The pixel response often varies from pixel to pixel. In some cases this may be due to variations in sensitivity of the sensor elements in an array. In other cases the illumination optics or imaging optics may introduce effects that are different at for different pixels in the image.

The situation may be understood with reference to FIG. 5. In this figure, the dashed line represents the imaging system response as a function of pixel position and the solid line represents a hypothetical set of pixel values for an image. An ideal imaging system would have a “flat” response, i.e., the response would be independent of the pixel position. The image response shown by the dashed line is non-flat, e.g., curved as a result of non-uniform pixel response in the system. Examples of factors that may cause non-uniform pixel response include variations in the pixel-to-pixel sensitivity of the image sensor/detectors, distortions in the optical path, illumination, sample tilt and sample preparation. The non-uniform response adversely affects image quality and sometime the background dominates the contrast so that it is difficult to see detail of image features when imaging. Thus, for images to be property viewed or evaluated, the non-uniformities should be corrected.

Many methods have been developed to effect a non-uniformity correction. Some methods use a reference-based correction. Specifically, a calibrated reference or flat field image is acquired offline or before collection of sample images, and pixel-dependent offset coefficients are computed for each pixel. The sample image is then collected and corrected based on the result from the reference image. However, recalibration is necessary for any changes in optics (e.g., refocus), mechanics (e.g., moving XYZ stage) and/or electronics (e.g., digital zoom) changes and such recalibration can take a significant amount of time. Other techniques involve defocusing the image on the array of detector elements and using the defocused image as a reference image. However, these techniques also involve moving mechanical parts (e.g., Z stage or optics) to accomplish the defocus and can take a significant amount of time. Accordingly, there is a need to develop a real-time correction method to remove non-uniformity noise or background from images. It is within this context that embodiments of the present invention arise.

### SUMMARY OF THE INVENTION

According to aspects of the present disclosure, a method of image correction may comprise acquiring a pixel value for each pixel in a raw image of a sample; obtaining a corresponding filtered pixel value for each pixel in the raw image by applying a filtering function to a subset of pixels in a window surrounding each pixel; obtaining pixel values for a final image by performing a pixel-by-pixel division of each pixel value of the raw image by the corresponding filtered pixel value; and displaying or storing the final image.

In some implementations, the subset of pixels may include every pixel in the window. In some of these implementations, replacing the pixel value of each pixel may further includes applying a second filtering function to every pixel surrounding each pixel in a second window and wherein the second window is smaller than the first window.

In some implementations, the subset of pixels includes less than all pixels in the window.

In some implementations, the window may be of a size about 1-3% of that of the raw image dimensions.

The window may be square, rectangular, round or any arbitrarily shape. By way of example, and not by way of limitation, the window may be a square window in a size of W×W pixels, where W is larger than 4.

In some implementations, the filtering function may be configured to attenuate high spatial frequency features in the raw image. In some implementations, obtaining the corresponding filtered pixel values may include obtaining a first pass filtered image by replacing the pixel value of each pixel in the raw image by applying a first filtering function to less than all pixels in a first window surrounding each pixel, and obtaining a second pass filtered image by replacing the pixel value of each pixel in the first pass filtered image by applying a second filtering function to all pixels in a second window surrounding each pixel, wherein the second window is smaller than the first window. The first filtering function and the second filtering function may use the same type of filter or different filters. The aim of the first pass is to get a coarse shape of the raw image with subset pixel sampling, and the aim of the second pass is to smooth the data. Two step of filtering may be designed to significantly reduce the total calculation time comparing once time larger window filtering without subset pixel sampling.

In some implementations, acquiring a pixel value for each pixel in a raw image of a sample includes acquiring the pixel value from a detector collecting electromagnetic radiation, and wherein the detector includes charge coupled device sensor arrays, Indium-Gallium-Arsenide (InGaAs) photodetector arrays or Mercury-Cadmium-Telluride (MCT) detector arrays. The electromagnetic radiation may be, e.g., infrared radiation.

In some implementations, the sample may be a semiconductor device.

In some implementations, a device having a processor and memory may be configured to perform the method. The device may include a storage device coupled to the processor for storing the final image and/or a display unit coupled to the processor for displaying the final image.

In some implementations, a nontransitory computer readable medium may contain program instructions for performing image correction on a raw image of sample, Execution of the program instructions by one or more processors of a computer system causes the one or more processors to carry out the method.

### BRIEF DESCRIPTION OF THE DRAWINGS

Objects and advantages of the invention will become apparent upon reading the following detailed description and upon reference to the accompanying drawings in which:

FIG. 1 is a schematic diagram of an optical system including an image processing device according to an aspect of the present disclosure.

FIG. 2 is a block diagram of an image processing device according to an embodiment of the present disclosure.

FIG. 3 is a flow diagram of an image correction method in accordance with an embodiment of the present disclosure.

FIG. 4A is a top view of a 2-D large window in an image correction method in accordance with an embodiment of the present disclosure.

FIG. 4B is a top view of a 2-D small window in an image correction method in accordance with an embodiment of the present disclosure.

FIG. 5 is a graph showing a flat image and a raw image with non-uniformity noises.

FIG. 6A is a raw image of a type that can be corrected in accordance with aspects of the present disclosure. The dark corners and central bright spot are to be attenuated after correction.

6B-6F are corrected images illustrating image correction in accordance with an aspect of the present disclosure using different window sizes.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention. Additionally, because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated. The following detailed description, therefore, is not to be taken in a limiting sense, and the scope of the present invention is defined by the appended claims.

Additionally, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a thickness range of about 1 nm to about 200 nm should be interpreted to include not only the explicitly recited limits of about 1 nm and about 200 nm, but also to include individual sizes such as but not limited to 2 nm, 3 nm, 4 nm, and sub-ranges such as 10 nm to 50 nm, 20 nm to 100 nm, etc. that are within the recited limits.

### GLOSSARY

As used herein:

Electromagnetic radiation refers to a form of energy emitted and absorbed by charged particles which exhibits wave-like behavior as it travels through space. Electromagnetic radiation includes, but is not limited to radiofrequency radiation, microwave radiation, terahertz radiation, infrared radiation, visible radiation, ultraviolet radiation, X-rays, and gamma rays.

Illuminating radiation refers to radiation that is supplied to a sample of interest as part of the process of generating an image of the sample.

Illuminating radiation refers to radiation that supplied from a sample of interest and is used by an imaging system to generate an image.

Infrared Radiation refers to electromagnetic radiation characterized by a vacuum wavelength between about 700 nanometers (nm) and about 100,000 nm.

Laser is an acronym of light amplification by stimulated emission of radiation. A laser is a cavity that is contains a lasable material. This is any material—crystal, glass, liquid, semiconductor, dye or gas—the atoms of which are capable of being excited to a metastable state by pumping e.g., by light or an electric discharge. Light is emitted from the metastable state by the material as it drops back to the ground state. The light emission is stimulated by the presence by a passing photon, which causes the emitted photon to have the same phase and direction as the stimulating photon. The light (referred to herein as stimulated radiation) oscillates within the cavity, with a fraction ejected from the cavity to form an output beam.

Light generally refers to electromagnetic radiation in a range of frequencies running roughly from the infrared through the ultraviolet corresponding to a range of vacuum wavelengths from about 1 nanometer (10⁻⁹ meters) to about 100 microns.

Radiation generally refers to energy transmission through vacuum or a medium by waves or particles, including but not limited to electromagnetic radiation, sound radiation, and particle radiation including charged particle (e.g., electron or ion) radiation or neutral particle (e.g., neutron, neutrino, or neutral atom) radiation.

Secondary radiation refers to radiation generated by a sample as a result of the sample being illuminated by illuminating radiation. By way of example, and not by way of limitation, secondary radiation may be generated by scattering (e.g., reflection, diffraction, refraction) of the illuminating radiation or by interaction between the illuminating radiation with the material of the sample (e.g., through fluorescence, secondary electron emission, secondary ion emission, and the like).

Ultrasound refers to oscillating sound pressure waves with a frequency greater than the upper limit of the human hearing range, e.g., greater than approximately 20 kilohertz (20,000 hertz), typically from about 20 kHz up to several gigahertz.

Ultraviolet (UV) Radiation refers to electromagnetic radiation characterized by a vacuum wavelength shorter than that of the visible region, but longer than that of soft X-rays.

Ultraviolet radiation may be subdivided into the following wavelength ranges: near UV, from about 380 nm to about 200 nm; far or vacuum UV (FUV or VUV), from about 200 nm to about 10 nm; and extreme UV (EUV or XUV), from about 1 nm to about 31 nm.

Vacuum Wavelength refers to the wavelength electromagnetic radiation of a given frequency would have if the radiation were propagating through a vacuum and is given by the speed of light in vacuum divided by the frequency of the electromagnetic radiation.

Visible radiation (or visible light) refers to Electromagnetic radiation that can be detected and perceived by the human eye. Visible radiation generally has a vacuum wavelength in a range from about 400 nm to about 700 nm.

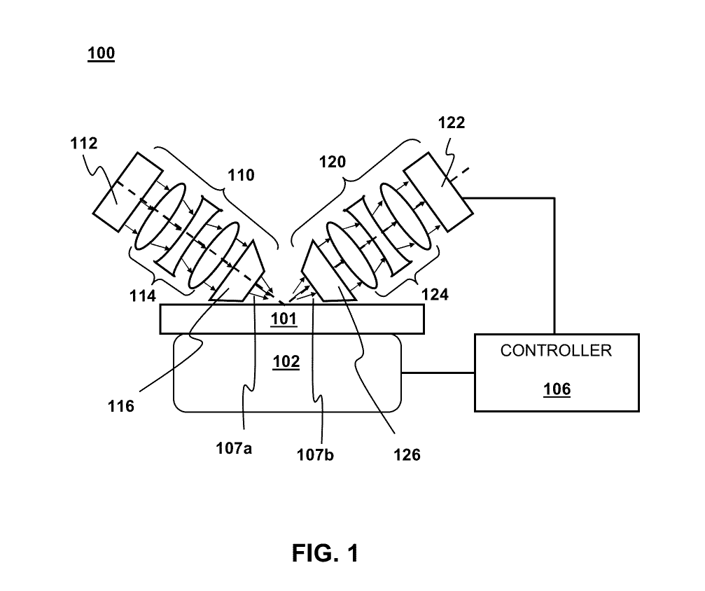

FIG. 1 is a schematic diagram of a system 100 in accordance with an aspect of the present disclosure. By way of example and not by way of limitation, the system 100 may be, for example, a microscope, such as an optical microscope, a scanning electron microscope, a scanning tunneling microscope, fluorescence microscope, or a laser scanning microscope. Alternatively, system 100 may be a digital camera system, telescopic, an imaging system, a thermographic imaging system, or an ultrasound imaging system. Specifically, the system 100 may include an illumination system 110 to provide illuminating radiation 107a to a sample 101. The sample 101 may be any suitable physical, biological, or astronomical object. By way of example, and not by way of limitation, the sample 101 may be a semiconductor device. The illumination system 110 may include a source 112, beam forming optics 114 and illumination objective 116. The source 112 emits an illumination beam 107a, which may be, for example, electromagnetic radiation such as visible light, infrared radiation, or emission of field electrons. By way of example, the source 112 may be a lamp, a fluorescence lamp, a semiconductor laser or an electron emitting device. Radiation from the source passes through the beam forming optics 114 which transforms the source radiation into a parallel beam. The parallel beam is then converged and focused by illumination objective 116 on the sample 101. It is noted that the illumination system 110 is optional.

Aspects of the present disclosure include embodiments in which the sample generates radiation without requiring illuminating radiation from a dedicated illumination system. For example, digital camera systems and the like may utilize naturally occurring illumination. Thermographic imaging systems and the like may image samples that generate radiation in the absence of external illumination.

Interaction between the radiation 107a and the sample 101 produces imaging radiation 107b, e.g., by diffracting, reflecting or refracting a portion of the illuminating radiation 107a or through generation of secondary radiation. The imaging radiation 107b passes through a collection system 120 which may include an objective 126, relay optics 124 and a detector 122. The objective 126 and the relay optics 124 transform the imaging radiation 107b into a parallel beam which is then collected by a detector 122. The image sensor(s) employed in the detector 122 may be different depending on the nature of the system 100. By way of example, and not by way of limitation, the detector 122 may include an array of image sensors that convert an optical image into a corresponding array of electronic signals. For example, the detector 122 may be charge coupled device (CCD) sensor array, or focal plane array (FPA) such as an InGaAs photodetector array or a Mercury-Cadmium-Telluride (MCT) detector array for sensing infrared radiation. In alternative implementations, for laser scanning microscopes, a photomultiplier tube (PMT) or avalanche photodiode may be employed as the detector 122. It should be noted that some elements (e.g., collimators or objective lens) may be shared between the illumination system 110 and the collection system 120. For example, the objective lens used in the illumination system 110 as illumination objective 116 may also be the objective 126 in the collection system 120.

An image processing controller 106 coupled to the detector 122 may be configured to perform image processing on data generated using the detector. In addition, the image processing controller 106 may optionally be coupled to a scanning stage 102 that holds the sample, and controls the movement of the stage for image scanning The image processing controller 106 may be configured to perform real-time image correction on acquired images in accordance with aspects of the present disclosure.

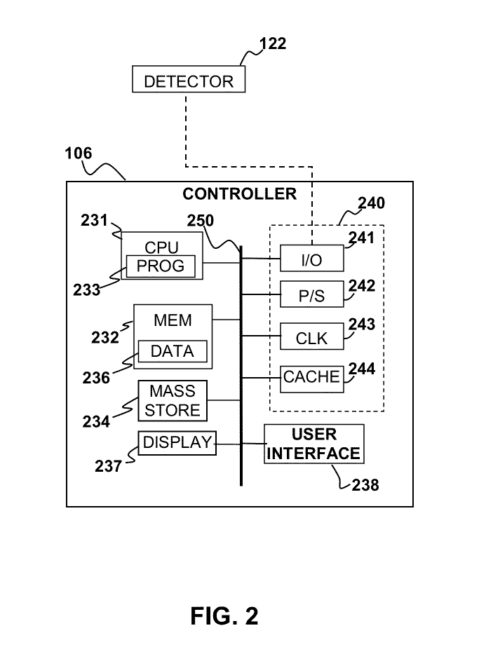

FIG. 2 is a block diagram of an image processing device 106 of FIG. 1. The image processing device 106 may include a central processor unit (CPU) 231 and a memory 232 (e.g., RAM, DRAM, ROM, and the like). The CPU 231 may execute an image correction program 233, portions of which may be stored in the memory 232. The memory may contain data 236 related to one or more images. In one example, the CPU 231 may be a multicore CPU. The image processing device 106 may also include well-known support circuits 240, such as input/output (I/O) circuits 241, power supplies (P/S) 242, a clock (CLK) 243 and cache 244. The image processing device 106 may optionally include a mass storage device 234 such as a disk drive, CD-ROM drive, tape drive, or the like to store programs and/or data. The image processing device 106 may also optionally include a display unit 237, e.g., cathode ray tube (CRT) or flat panel, and user interface unit 238 to facilitate interaction between the image processing device 106 and a user. The display unit 237 may be in the form of a cathode ray tube (CRT) or flat panel screen that displays text, numerals, or graphical symbols. The user interface 238 may include a keyboard, mouse, joystick, light pen or other device. The preceding components may exchange signals with each other via an internal system bus 250. The image processing device 106 may be a general purpose computer that becomes a special purpose computer when running code that implements aspects of the present disclosure as described herein. According to one embodiment of the present disclosure, the image correction program 233 stored in the memory 232 and executed by the CPU 231 is an image correction method including processes of acquiring a raw image, applying a filtering function to the raw image and displaying or storing a final image.

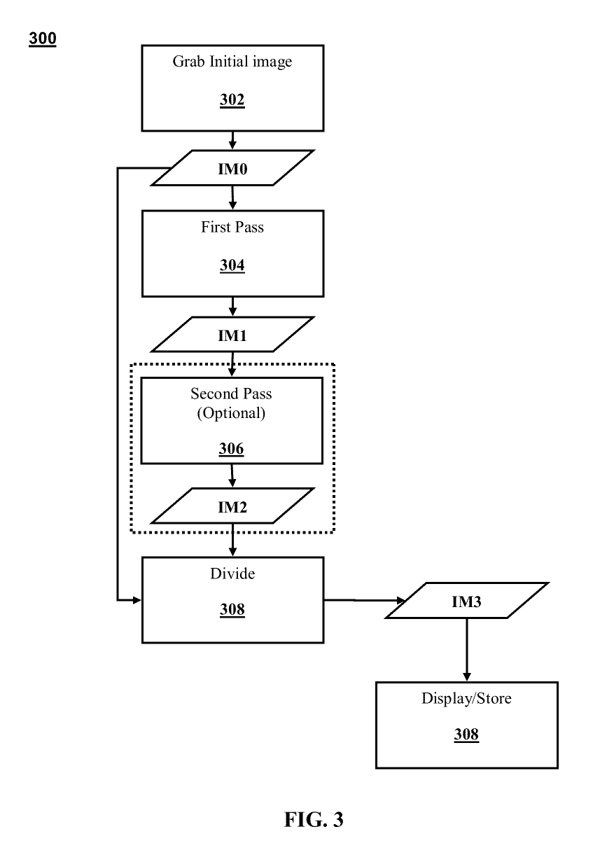

FIG. 3 is a flow diagram of an image correction method in accordance with an embodiment of the present disclosure. At step 302, a raw image IM0 of the sample 101 may be acquired from a detector 122 and/or memory 232. The raw image IM0 includes a plurality of pixels, each of which has a pixel location and corresponding pixel value.

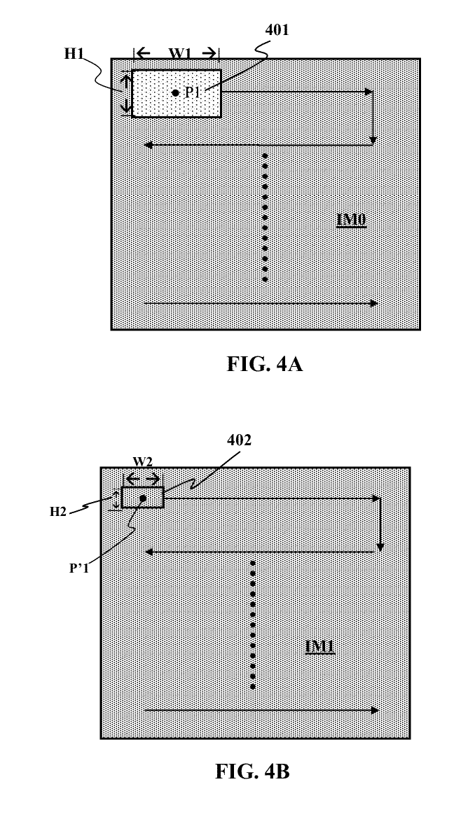

At step 304, a filtering function is employed on a subset of pixels of the raw image to remove image variation to form a filtered image that represents a shape of the raw image. Specifically, the raw image IM0 is scanned by means of a two dimensional sliding window 401 as shown in FIG. 4A, which covers an area of pixels surrounding a pixel of interest P1. The size of window (W) is a flat factor to control the flatness of the final image. That is, for a smaller the window size, the final image will be flatter and the calculation takes less time. The size of the window may also depend on the field of view. A larger sized window may be used for a smaller field of view and a smaller sized window may be used for a larger field of view. Generally, the size of the large window may be about 1-3% of the image dimensions (e.g., width or height). The 2-D window may be square, rectangular, round, or any arbitrarily shape. An example in which the window is rectangular is shown in FIG. 4A. The window size may be W1×H1 pixels, where W1 and H1 represent the width and height of the window in pixels. As a numerical example, the window size may be between 8×8 to 32×32 pixels for an image roughly 1000 pixels by 1000 pixels.

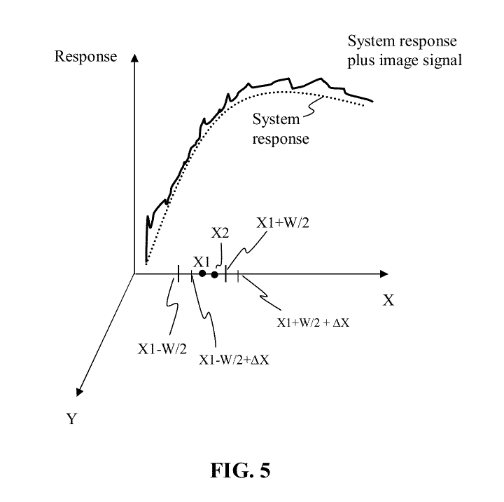

A filtering function is applied to a subset of the pixels in the window 401 to obtain a new pixel value of the pixel of interest P1. Generally speaking, the filter function may be a low pass filter function that removes higher spatial frequency features. There are many ways to implement such a low pass filter, such as linear or non-linear, first-order filter or second-order filter. The accuracy for the flat field data is not that sensitive and critical as long as it extracts the shape and also smoothens. By way of example and not by way of limitation, the filtering function may be any function that is applied in image processing to remove high spatial frequency features and smooth images, such as smoothing, mean, median, low pass filter, Gaussian filters or Fast Fourier Transform (FFT), Chebyshev functions, Butterworth functions, Bessel functions, and the like. The subset of the pixels that applies the filtering function may include between all and 1/16 of the pixels in the window. By way of example but not by way of limitation, the filtering function may be applied to every N^{th} pixel in the window, and N may be 1, 2, 4, 8, or 16. It should be noted that the pixels in the window may be arbitrarily weighted with different weights applied to different pixels. The window 401 may slide over the entire raw image IM0 in a raster scan order as shown in FIG. 4A. With reference to FIG. 5, the pixel value calculation is explained with a one dimensional window for simplicity. The window size is W. The first pixel of interest is located at X1. A subset of the pixels located between X1−W/2 and X1+W/2 applies a filtering function. That is, the pixel values of some of the pixels, if not all, in the window are used to generate an updated pixel value of the first pixel of interest located at X1. The data picked or sampling for the filtering can be skipped by ΔX pixels in the window to reduce the calculation time. The procedure for pixel value calculation is repeated for each pixel of the entire raw image.

It should be noted that a person skilled in the art would understand how to apply the above pixel value calculation with a 2-D window. After the pixel value of each pixel of the raw image has been calculated, a filtered image IM1 is formed. The filtered image IM1 may be then used as a divider at step 308 to create a final image IM3. At step 310, the final image IM3 may be displayed or stored in the storage medium such as memory 232 or a mass storage device 234.

Optionally, an additional step of applying a second filtering function may be added after step 304 if a subset of pixels in the window was used, e.g., certain pixels were skipped in the sampling of a first filtering function. Specifically, at step 306, the filtered image IM1 may be scanned with a second sliding window 402 of FIG. 4B in a size of W2×H2 pixels for example. The size of the second window 402 is smaller than the size of the first window 401. The size of the second window may depend on the number of pixels skipped in the first window at step 304. For example, when every fourth pixel applies the first filtering function in a first window of 16×16 pixels, the second window would be in a size of 4×4 pixels. No pixels would be skipped in the second window for filtering because this step is to smooth arbitrary noise that might be generated as a result of skipping sampling pixels in the first filtering pass.

A second filtering function is applied to each pixel of the filtered image IM1 in the second window 402 to form a second filtered image IM2 The filter type used in second filtering function may be the same as the filter in the first filtering function at step 306 or may be a different filter type. The smaller window slides over the entire filtered image IM1 as shown in FIG. 4B. After the pixel value for each pixel of the filtered image has been calculated, a second filtered image IM2 may be formed. The second filtered image IM2 may be used as a divider at step 308 to create a final image IM3 to be displayed or stored at step 310. In one embodiment, when the first window size is small (i.e., W is less or equal to 4), only one filtering function is applied (Step 304) to preferably every pixel in the window.

In order to get the “shape” of the raw image IM0, a larger window size may be used in a single pass. A longer calculation time may be required if skipped pixel sampling is not used in the single pass. If skipped pixel sampling is used in a single pass to save time, but with no second pass, there may be spike noises in the final image.

As an example, consider a raw image of size 512×512 pixels using a large window size W1×H1 of 16×16 pixels and a smaller window W2×H2 of 4∴4 pixels. In this example the filter function is an average filter. The pixel value at a given location X,Y is denoted P(X,Y) and the filtered pixel value is denoted F(X,Y).

In first pass, filtered pixel values F(X,Y) are calculated using every 4^{th} pixel in the large window. In this example, therefore, ΔX=4.

F(X,Y)=1/A*(P(X−8,Y−8)+P(X−4,Y−8)+P(X,Y−8)+P(X+4,Y−8)+P(X+8,Y−8)+P(X−8,Y−4)+P(X−4,Y−4)+P(X,Y−4)+P(X+4,Y−4)+P(X+8,Y−4)+P(X−8,Y)+P(X−4,Y)+P(X,Y)+P(X+4,Y)+P(X+8,Y)+P(X−8,Y+4)+P(X−4,Y+4)+P(X,Y+4)+P(X+4,Y+4)+P(X+8,Y+4)+P(X−8,Y+8)+P(X−4,Y+8)+P(X,Y+8)+P(X+4,Y+8)+P(X+8,Y+8)).

Here, A=25, the number of points used to calculate the average.

In second pass, ΔX=1. The final filtered pixel values F′(X, Y) will be:

F′(X,Y)=1/A*(F(X−2,Y−2)+F(X−1,Y−2)+F(X,Y−2)+F(X+1,Y−2) +F(X+2,Y−2)+F(X−2,Y−1)+F(X−1,Y−1)+F(X,Y−1)+F(X+1,Y−1)+F(X+2,Y−1)+F(X−2,Y)+F(X−1,Y)+F(X,Y) +F(X+1,Y)+F(X+2,Y)+F(X−2,Y+1)+F(X−1,Y+1) +F(X,Y+1)+F(X+1,Y+1)+F(X+2,Y+1)+F(X−2,Y+2)+F(X−1,Y+2)+F(X,Y+2)+F(X+1,Y+2)+F(X+2,Y+2)).

Again, A=25, the number of points used to calculate the average.

Every step of the filtering process is applied to all pixels in the image.

In an edge or corner, because the valid data for averaging reduced, F(X,Y) or F′(X,Y) can be calculated using whatever points in the window are valid and the value of A may be determined based on which points in the window are valid. For example, for the point (X=0, Y=0), points in the window for which X<0 or Y<0 are not valid. The calculation of F(0,0) may be:

F(0,0)=1/A′*(P(X,Y)+P(X+4,Y)+P(X+8,Y)+P(X,Y+4)+P(X+4,Y+4)+P(X+8,Y+4)+P(X,Y+8)+P(X+4,Y+8)+P(X+8,Y+8)),

where A′=9.

Similarly, F′(0,0) may be calculated as:

F′(0,0)=1/A′*(F(X,Y)+F(X+1,Y)+F(X+2,Y)+F(X,Y+1) +F(X+1,Y+1)+F(X+2,Y+1)+F(X,Y+2)+F(X+1,Y+2)+F(X+2,Y+2)).

Again, A′=9.

The final pixel values P′(X,Y) for the corrected image can be generated by doing a simple pixel by pixel division of the raw pixel value P(X,Y) by the final filtered pixel value F′(X,Y), i.e., P′(X,Y)=P(X,Y)/F′(X,Y).

The two step filtering can significantly reduce calculation time for generating a filtered image for autoflat correction. Generally speaking, if every N^{th} pixel is used in a first window of size W1×H1 pixels and the second window has a size of N×N pixels, the two step method can be faster by a factor of

W1×H1/(W1/N×H1/N+N×N) compared to a single pass method with a no skipped pixels filter.

By way of numerical example, for W1×H1=16×16 and N=4, the two pass method can be calculated to be (16×16)/(16/4×16/4+4×4)=8× faster than a single pass “no skip” filtered image generation with a 16×16 window.

According to the image correction method, a real-time reference or flat field image can be obtained quickly. With such method, it generally takes about less than 1 second on a 1K×1K pixel image (i.e., 1 mega pixels) In addition, the controller 106 may be configured to automatically trigger generation of a filtered image, e.g., for auto-flat correction, when any change occurs in the optical system 100. By way of example, and not by way of limitation, changes that could trigger real time generation of an updated filtered image include, but are not limited to, moving the sample 101, re-focusing the collection system 120, changing illumination, changing the objective 126, changing polarization of illumination, changing exposure time or integration time, or a user request. Taking a reference/flat field image automatically, sometimes referred to as “Auto Flat”, can be triggered by any of the above events or some combination thereof. The controller 106 may be configured such that the feature of updating a real-time reference image may be turned on or off by a user. A separate real-time reference image may be taken for each frame of a stitched image during acquisition.

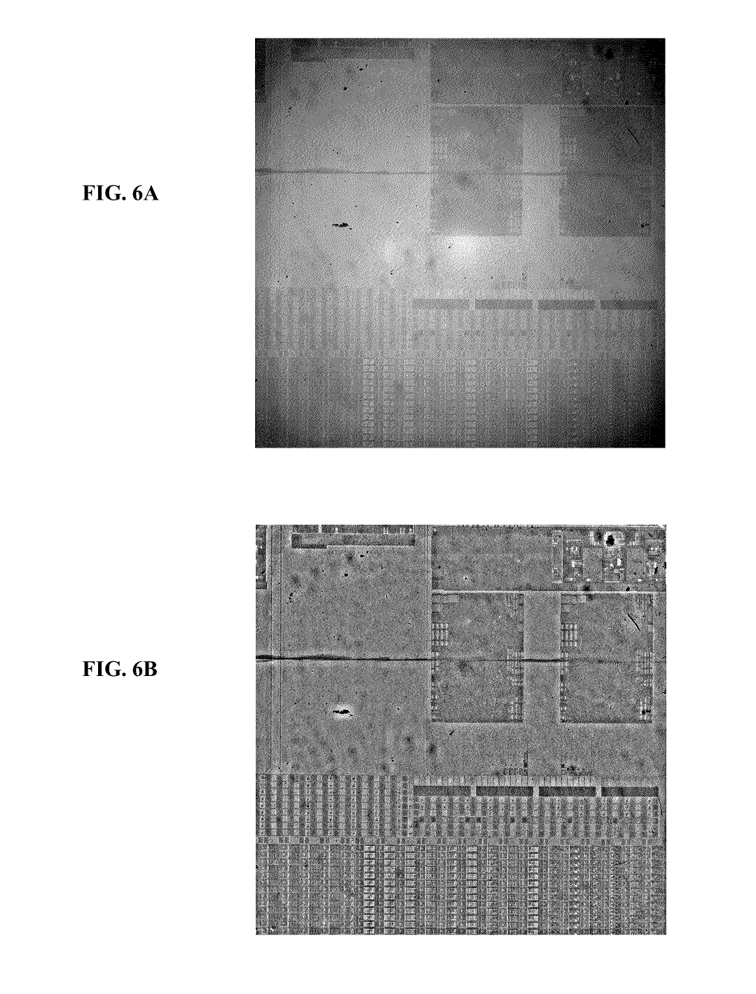

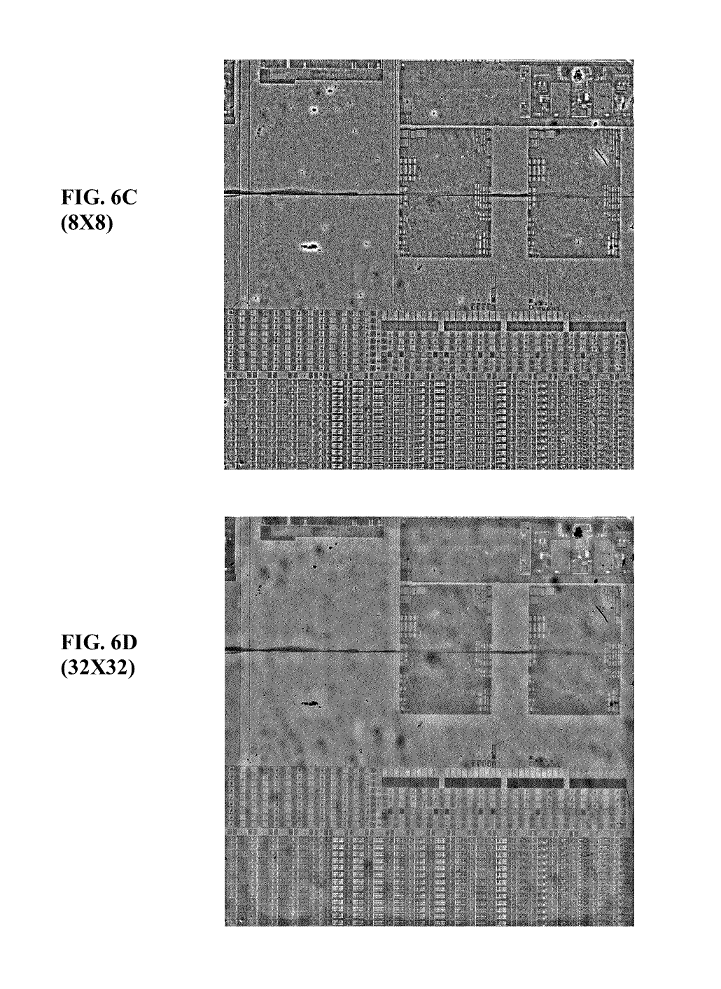

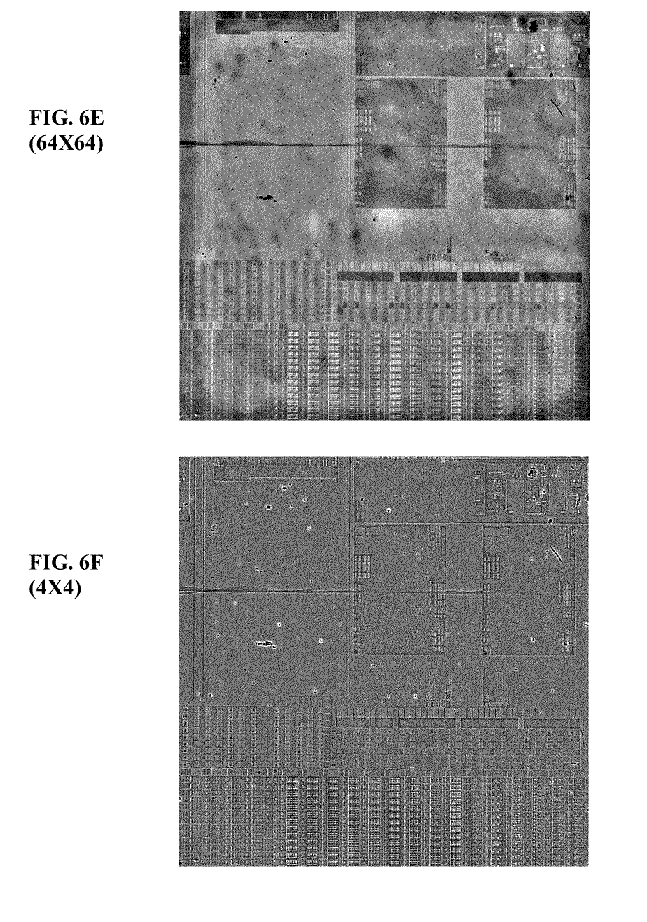

The advantages of image correction in accordance with the present disclosure may be seen in the examples depicted in FIG. 6A-6X. FIG. 6A is an example of a raw image. The “non-flat” nature of the image can be seen in the dark regions at the corners and a bright spot in the center. FIG. 6B is a final image obtained after a two-step filtering process done on the same image has generated a filtered image (e.g., a reference flat) that is used to correct the raw image. In this example, the images are 1K×1K pixels in size. A 16×16 pixel window was used in a first filtering pass and a 4×4 window was used in the second pass. Every fourth pixel was used in the 16×16 window in the first pass and every pixel in the 4×4 window was used in the second pass.

The effect of different window sizes can be seen in FIGS. 6C-6F. In FIG. 6C, an 8×8 pixel window was used in a first filtering pass and a 4×4 window was used in the second pass.

Every fourth pixel was used in the 8×8 window in the first pass and every pixel in the 4×4 window was used in the second pass. In FIG. 6D, a 32×32 pixel window was used in a first filtering pass and a 4×4 window was used in the second pass. Every fourth pixel was used in the 32×32 window in the first pass and every pixel in the 4×4 window was used in the second pass. In FIG. 6E, a 64×64 pixel window was used in a first filtering pass and a 4×4 window was used in the second pass. Every fourth pixel was used in the 64×64 window in the first pass and every pixel in the 4×4 window was used in the second pass. Note the darkening at the edges and corners of the image relative to the rest of the image. In FIG. 6F, a 4×4 window was used in a single pass. Every pixel in the 4×4 window was used in the single pass.

The appended claims are not to be interpreted as including means-plus-function limitations, unless such a limitation is explicitly recited in a given claim using the phrase “means for.” Any element in a claim that does not explicitly state “means for” performing a specified function, is not to be interpreted as a “means” or “step” clause as specified in 35 USC §112, ¶6. In particular, the use of “step of” in the claims herein is not intended to invoke the provisions of 35 USC §112, ¶6.

What is claimed is:

1. A method of image correction comprising:
acquiring a pixel value for each pixel in a raw image of a sample;
obtaining a corresponding filtered pixel value for each pixel in the raw image by applying a filtering function to a subset of pixels in a window surrounding each pixel;
obtaining pixel values for a final image by performing a pixel-by-pixel division of each pixel value in the raw image by the corresponding filtered pixel value; and
displaying or storing the final image.

2. The method of image correction of claim 1, wherein the subset of pixels includes every pixel in the window.

3. The method of image correction of claim 1, wherein the subset of pixels includes less than all pixels in the window.

4. The method of image correction of claim 3, wherein replacing the pixel value of each pixel further includes applying a second filtering function to every pixel surrounding each pixel in a second window and wherein the second window is smaller than the first window.

5. The method of image correction of claim 1, wherein the window is in a size from about 1% to about 3% of that of the raw image dimension.

6. The method of image correction of claim 1, wherein the window is square, rectangular, round or any arbitrarily shape.

7. The method of image correction of claim 6, wherein the window is a square window in a size of W×W pixels, where W is larger than 4.

8. The method of image correction of claim 1, wherein the filtering function is configured to attenuate high spatial frequency features in the raw image.

9. The method of image correction of claim 1, wherein obtaining the corresponding filtered pixel value for each pixel in the raw image includes obtaining a first pass filtered image by replacing the pixel value of each pixel in the raw image by applying a first filtering function to less than all pixels in a first window surrounding each pixel, and obtaining a second pass filtered image by replacing the pixel value of each pixel in the first pass filtered image by applying a second filtering function to all pixels in a second window surrounding each pixel, wherein the second window is smaller than the first window.

10. The method of claim 10 wherein the first filtering function and the second filtering function are the same.

11. The method of claim 10 wherein the first filtering function and the second filtering function are different.

12. The method of image correction of claim 1, wherein acquiring a pixel value for each pixel in a raw image of a sample includes acquiring the pixel value from a detector collecting electromagnetic radiation, and wherein the detector includes charge coupled device sensor arrays, InGaAs photodetector arrays or Mercury-Cadmium-Telluride (MCT) detector arrays.

13. The method of image correction of claim 12, wherein the electromagnetic radiation is infrared radiation.

14. The method of image correction of claim 1, wherein the sample is a semiconductor device.

15. A device for performing image correction method, comprising:
a processor configured to acquire a pixel value for each pixel in a raw image of a sample,
obtain a corresponding filtered pixel value for each pixel in the raw image by applying a filtering function to a subset of pixels in a window surrounding each pixel in the raw image, and
obtain pixel values for a final image by performing a pixel-by-pixel division of each pixel value of the raw image by the corresponding filtered pixel value; and
a memory coupled to the processor configured to store data related to at least one of the raw image, the filtered pixel values and the final image.

16. The device of claim 13, further comprising a storage device coupled to the processor for storing the final image.

17. The device of claim 13, further comprising a display unit coupled to the processor for displaying the final image.

18. The device of claim 13, wherein the processor is configured to obtain the corresponding filtered pixel value for each pixel in the raw image automatically in response to a change in an optical system used to generate the raw image.

19. A nontransitory computer readable medium containing program instructions for performing image correction on a raw image of a sample, wherein execution of the program instructions by one or more processors of a computer system causes one or more processors to carry out a method for image correction, the method comprising:
acquiring a pixel value for each pixel in a raw image of a sample;
obtaining a corresponding filtered pixel value for each pixel in the raw image by applying a filtering function to a subset of pixels in a window surrounding each pixel;
obtaining pixel values for a final image by performing a pixel-by-pixel division of each pixel value of the raw image by the corresponding filtered pixel value; and
displaying or storing the final image.

20. The nontransitory computer readable medium of claim 18, wherein the subset of pixels includes less than all pixels in the window.

21. The nontransitory computer readable medium of claim 18, wherein obtaining the corresponding filtered pixel value for each pixel in the raw image includes obtaining a first pass filtered image by replacing the pixel value of each pixel in the raw image by applying a first filtering function to less than all pixels in a first window surrounding each pixel, and obtaining a second pass filtered image by replacing the pixel value of each pixel in the first pass filtered image by applying a second filtering function to all pixels in a second window surrounding each pixel, wherein the second window is smaller than the first window.
